(19) United States
(12) Patent Application Publication
(10) Pub. No.: US 2026/0171770 A1
(43) Pub. Date: Jun. 18, 2026

(54) WIRE ROUTING UNIT AND WIRE HARNESS

(71) Applicant: YAZAKI CORPORATION, Tokyo (JP)

(72) Inventor: Naoto Kogure, Makinohara-shi (JP)

(21) Appl. No.: 19/415,697

(22) Filed: Dec. 10, 2025

(30) Foreign Application Priority Data
Dec. 16, 2024 (JP) 2024-219616

(51) Int. Cl. H02G 3/04

(52) U.S. Cl. CPC H02G 3/0456

(57) ABSTRACT

A wire routing unit includes: a first fixing part that is fixed to a fixing target; a second fixing part that is provided by being spaced from the first fixing part and fixed to the fixing target; and a connecting part that has flexibility and connects the first fixing part and the second fixing part, in which the connecting part is formed by winding a wire rod in a helical manner, and configured to allow a wire to be inserted into the inside and held.

### CROSS-REFERENCE TO RELATED APPLICATION(S)

The present application claims priority to and incorporates by reference the entire contents of Japanese Patent Application No. 2024-219616 filed in Japan on Dec. 16, 2024.

### BACKGROUND OF THE INVENTION

### 1. Field of the Invention

The present invention relates to a wire routing unit and a wire harness.

### 2. Description of the Related Art

As a conventional wire routing unit and wire harness, as described in JP 2024-006 300 A, for example, there is a known wire routing unit (wiring regulation member) that includes a first holding part and a second holding part for holding wire members, in which the first holding part and the second holding part are connected by a first regulation member and a second regulation member, and the first regulation member and the second regulation member are connected by a connecting member. This wire routing unit can be deformed according to the routing path of the wire members by allowing the connecting member to change the angle formed by the first regulation member and the second regulation member, thereby improving the versatility of a wiring path regulation member.

By the way, there is room for improvement in the above-mentioned wire routing unit and wire harness in that it is sometimes difficult to properly route and secure the wires in accordance with the routing path. For example, when it is desired to route the wires in a curved manner, it is difficult with the wire routing unit described above to properly route the wires along a curved routing path.

### SUMMARY OF THE INVENTION

It is therefore an object of the present invention to provide a wire routing unit and a wire harness capable of properly routing wires along a routing path.

In order to achieve the above mentioned object, a wire routing unit according to one aspect of the present invention includes a first fixing part that is fixed to a fixing target; a second fixing part that is fixed to the fixing target; and a connecting part that has flexibility and connects the first fixing part and the second fixing part, wherein the connecting part is formed by winding a wire rod in a helical manner, and allows a wire to be inserted into an inside and held.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a wire routing unit and a wire harness according to an embodiment;

FIG. 2 is a perspective view of the wire routing unit and the wire harness according to the embodiment; and

FIG. 3 is an explanatory diagram of a wire routing unit according to a comparative example.

### DETAILED DESCRIPTION OF THE PREFERRED EMBODIMENTS

Hereinafter, an embodiment according to the present invention will be described in detail with reference to the accompanying drawings. It is to be noted that the present invention is not limited by the embodiment. Furthermore, the structural components in the following embodiment include those that are easily replaceable by those skilled in the art, or those that are substantially the same.

### Embodiment

The present embodiment relates to a wire routing unit and a wire harness. In the following description, in regards to a first direction, a second direction, and a third direction intersecting with each other, the first direction is referred to as an “extension direction X”, the second direction as a “width direction Y”, and the third direction as a “height direction Z”. Herein, the extension direction X, the width direction Y, and the height direction Z are orthogonal to each other. Note that orthogonal herein includes nearly orthogonal. The extension direction X corresponds, for example, to the direction along which the wire extends. Unless otherwise noted, each of the directions used in the following description indicates the direction in a state where the parts are assembled with each other.

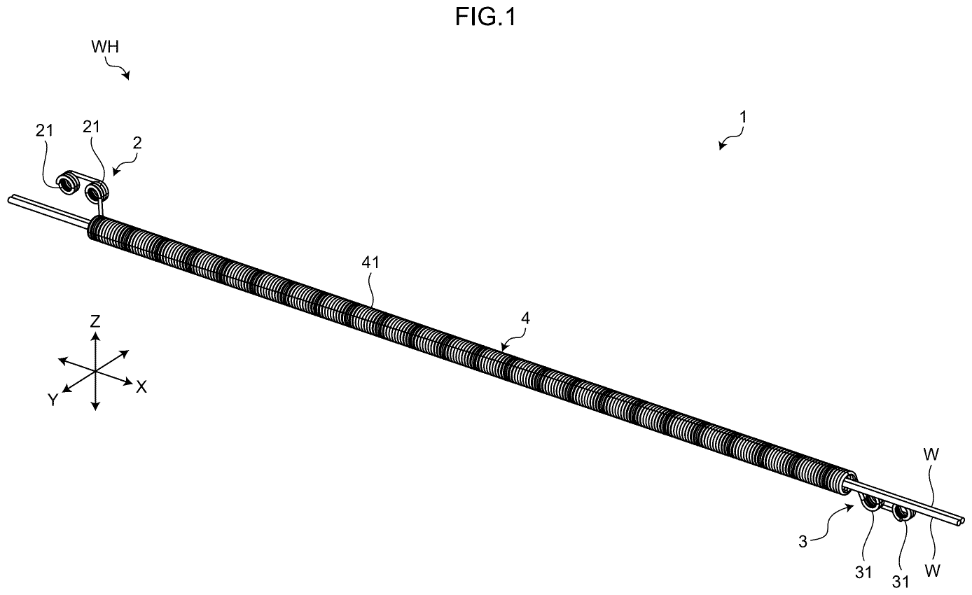

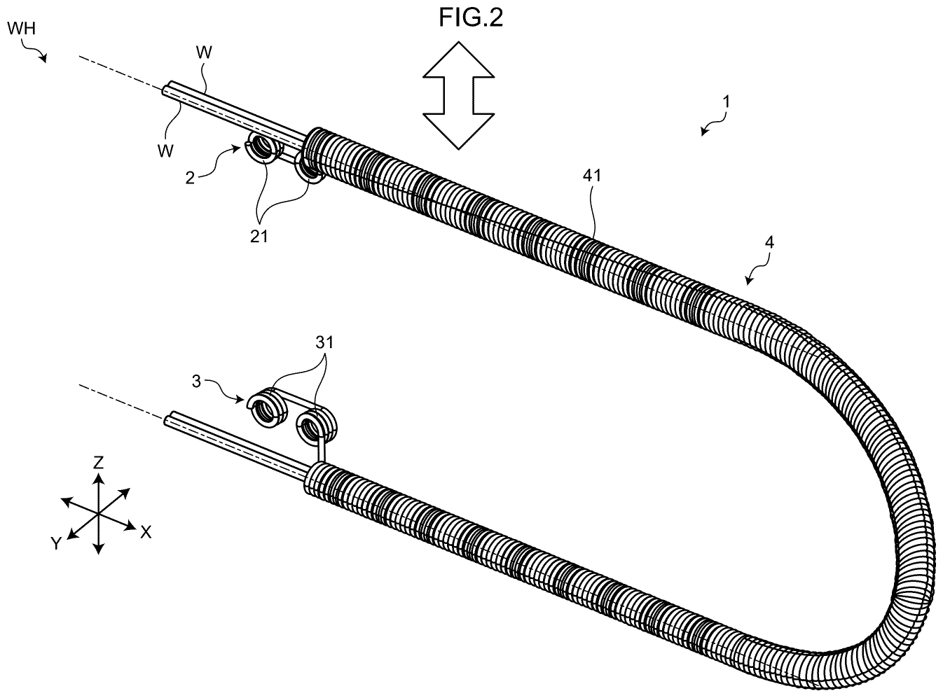

As illustrated in FIG. 1 and FIG. 2, a wire routing unit 1 according to the present embodiment is a unit for routing and fixing wires W to a fixing target, and it is used, for example, by being loaded on a vehicle. More specifically, the wire routing unit 1 is used for routing transmission movable wires. The wire W is a wiring member or conductive member for enabling electrical connection. For example, a sheathed wire in which the outer periphery of a conductive wire is covered by an insulator is used. As for the wire W, two of those are provided in parallel, for example. Note that number of wires W installed is not limited thereto. The wire routing unit 1 also functions as a wire harness WH including the wires W. FIG. 1 illustrates the wire routing unit 1 and the wire harness WH in a state where the wires W are routed in a straight form, and FIG. 2 illustrates the wire routing unit 1 and the wire harness WH in a state where the wires W are routed along a curved path.

The wire routing unit 1 includes a first fixing part 2, a second fixing part 3, and a connecting part 4. The first fixing part 2 is a part that is fixed to a fixing target, and fixes the wire routing unit 1 to the fixing target. The fixing target may be, for example, the body of a vehicle, a vehicle component, an electrical device loaded on a vehicle, or the like. The first fixing part 2 is formed by drawing a wire rod 41 that forms the connecting part 4 from the connecting part 4, and it includes a ring part 21. The ring part 21 is a part where the wire rod 41 is formed into an annular shape, and it is fixed to the fixing target by allowing a fastening member to be inserted therein. The ring part 21 is formed to allow the fastening member to be inserted in a direction that intersects with the extension direction X of the wire W. For example, it is formed to allow the fastening member extending in the width direction Y to be inserted therein.

As for the ring part 21, two of those are provided in a connected manner, for example. Specifically, two ring parts 21 are provided side by side in the extension direction X. Since the first fixing part 2 includes the two ring parts 21, it is possible to insert the fastening member to each of the ring parts 21 to suppress the first fixing part 2 from rotating. Therefore, the first fixing part 2 can properly fix the wire routing unit 1 and the wire harness WH in a desired posture and properly route the wires W.

The second fixing part 3 is a part that is fixed to a fixing target, and fixes the wire routing unit 1 to the fixing target. The second fixing part 3 is provided by being spaced from the first fixing part 2, and fixes the wire routing unit 1 at a position different from the first fixing part 2. The second fixing part 3 is formed by drawing the wire rod 41 that forms the connecting part 4 from the connecting part 4, and it includes a ring part 31. The ring part 31 is a part where the wire rod 41 is formed into an annular shape, and it is fixed to the fixing target by allowing a fastening member to be inserted therein. The ring part 31 is formed to allow the fastening member to be inserted in a direction that intersects with the extension direction X of the wire W. For example, it is formed to allow the fastening member extending in the width direction Y to be inserted therein.

As for the ring part 31, two of those are provided in a connected manner, for example. Specifically, the ring parts 31 are provided side by side in the extension direction X. Since the second fixing part 3 includes the two ring parts 31, it is possible to insert the fastening member to each of the ring parts 31 to suppress the second fixing part 3 from rotating. Therefore, the second fixing part 3 can properly fix the wire routing unit 1 and the wire harness WH in a desired posture and properly route the wires W.

The connecting part 4 is a part that connects the first fixing part 2 and the second fixing part 3, and exhibits flexibility. The connecting part 4 is formed by winding the wire rod 41 in a helical manner, and holds the wires W by inserting the wires W into the inside to regulate the routing path of the wires W. The connecting part 4 is formed by winding the wire rod 41 in a helical manner, which makes it possible to be bent and deformed to the extension direction. Therefore, by inserting the wires W inside the connecting part 4 and deforming the connecting part 4, the wires W can be routed along the curved routing path.

As illustrated in FIG. 1, the wire routing unit 1 allows the wires W to be routed in a straight form by making the connecting part 4 straight. Furthermore, as illustrated in FIG. 2, with the wire routing unit 1, the wires W can be routed along the curved routing path by bending the connecting part 4. The wire rod 41 is configured with a material that deforms elastically or plastically. For example, it is formed with resin or metal.

The connecting part 4 is configured with a single wire rod 41. Furthermore, the connecting part 4 is configured using a single wire rod 41 together with the first fixing part 2 and the second fixing part 3. In other words, the connecting part 4, the first fixing part 2, and the second fixing part 3 are formed by processing or deforming the single wire rod 41. This makes it possible to reduce the number of components and configure the wire routing unit 1 with fewer components, compared to the case where the connecting part 4, the first fixing part 2, and the second fixing part 3 are formed by separate members.

Next, a use method of the wire routing unit 1 and the wire harness WH according to the present embodiment will be described.

As illustrated in FIG. 1, the wire routing unit 1 is externally attached to the wires W, holds the wires W such that the wires W are routed along the routing path, and is fixed to the fixing target.

First, the wire routing unit 1 is attached to the wires W. In other words, the wires W are inserted into the connecting part 4 to externally cover the wires W with the connecting part 4, thereby attaching the wire routing unit 1 the wires W. For example, as illustrated in FIG. 1, when the wires W are routed in a straight form, the wire routing unit 1 is installed such that the connecting part 4 is in a straight form.

The wire routing unit 1 is fixed to the fixing target by fixing the first fixing part 2 and the second fixing part 3 to the fixing target. In other words, the first fixing part 2 is fixed to the fixing target by inserting a fastening member into the ring part 21. For example, the first fixing part 2 is fastened by inserting a boss protruding from the fixing target into one of the two ring parts 21 and inserting a fastening member such as a bolt into the other of the two ring parts 21. Thereby, the first fixing part 2 is suppressed from rotating about the ring part 21 and properly fixed. Also, the second fixing part 3 is fixed to the fixing target by inserting a fastening member into the ring part 31. For example, as in the case of the first fixing part 2, the second fixing part 3 is fastened by inserting a boss protruding from the fixing target into one of the two ring parts 31 and inserting a fastening member such as a bolt into the other of the two ring parts 31. Thereby, the second fixing part 3 is suppressed from rotating about the ring part 31 and properly fixed.

For example, as illustrated in FIG. 2, when the wires W are routed in a curved manner, the wire routing unit 1 is installed such that the connecting part 4 is deformed in a curved manner. In this case, the wire routing unit 1 is also fixed to the fixing target by fixing the first fixing part 2 and the second fixing part 3 to the fixing target.

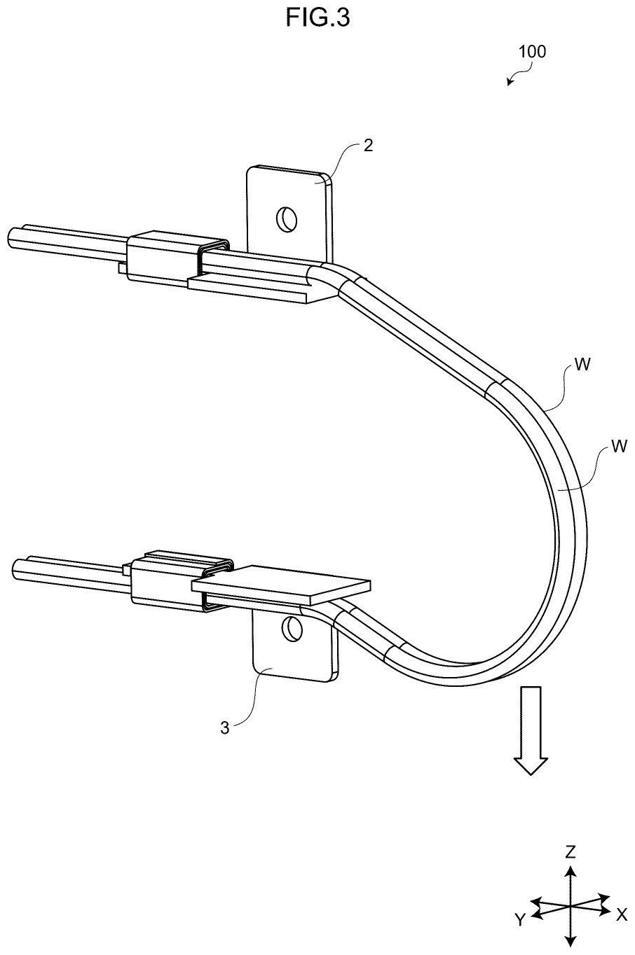

The wires W are held by the connecting part 4 between the first fixing part 2 and the second fixing part 3 and properly routed along the connecting part 4. For example, as illustrated in FIG. 3, for example, in a case of a wire routing unit 100 where the connecting part 4 is not provided between the first fixing part 2 and the second fixing part 3, it is difficult for the wires W to be properly routed. In other words, the wires W are routed between the first fixing part 2 and the second fixing part 3 while hanging down due to their own weight. In particular, when routed in a curved manner, the wires W may come to hang down significantly. In this case, there is a concern that the wires W may also sway significantly due to vibration. In addition, part of the wires W extending from the first fixing part 2 and the second fixing part 3 is bent and stress is then concentrated thereon. On the contrary, with the wire routing unit 1 according to the present embodiment, the wires W can be supported by bending the connecting part 4 between the first fixing part 2 and the second fixing part 3. Therefore, with the wire routing unit 1 and the wire harness WH according to the present embodiment, it is possible to prevent the wires W from hanging down to be routed between the first fixing part 2 and the second fixing part 3, and to suppress the stress from concentrating on the wires W, thereby making it possible to properly route the wires W.

As illustrated in FIG. 2, the wire routing unit 1 may also be used in a mode in which one of the first fixing part 2 and the second fixing part 3 is moved. In other words, in a state where the connecting part 4 is installed to be bent and the wires W are routed along the connecting part 4 in a curved manner, the wire routing unit 1 may be used in a mode in which the first fixing part 2 and the second fixing part 3 are moved to be distant or to be close to each other. In this case, the curvature of the connecting part 4 and the wires W come to change due to the move of the first fixing part 2 or the second fixing part 3. Since the connecting part 4 exhibits flexibility, it can be deformed and bent by changing the curvature in accordance with the move of the first fixing part 2 or the second fixing part 3 to properly support the wires W. Therefore, with the wire routing unit 1 and the wire harness WH according to the present embodiment, it is possible to suppress the stress from concentrating on the wires W and to bend and properly route the wires W even when used in a mode in which the first fixing part 2 or the second fixing part 3 is moved.

The wire routing unit 1 and the wire harness WH enable smooth fixing work to the fixing target through connecting the first fixing part 2 and the second fixing part 3 by the connecting part 4. For example, in the wire routing unit 1, when the first fixing part 2 is fixed to the fixing target, the direction and position regarding the fixing position of the second fixing part 3 is limited by the connecting part 4, which prevents the wires W from being twisted to be routed, and makes it easy to do the fixing work of the second fixing part 3. Therefore, the wire routing unit 1 and the wire harness WH enable smooth fixing work to the fixing target compared to a case where the connecting part 4 is not provided.

As described above, with the wire routing unit 1 and the wire harness WH according to the present embodiment, the routing path of the wires W between the first fixing part 2 and the second fixing part 3 can be regulated by the connecting part 4 through connecting the first fixing part 2 and the second fixing part 3 using the helically formed connecting part 4, thereby making it possible to properly regulate the routing path even though the routing path is curved. Therefore, with the wire routing unit 1 and the wire harness WH according to the present embodiment, the wires W can be properly routed along the routing path.

Furthermore, in the wire routing unit 1 according to the present embodiment, the ring part 21 of the first fixing part 2 and the ring part 31 of the second fixing part 3 as well as the connecting part 4 can be configured with the wire rod 41. Therefore, the number of components can be reduced compared to the case where the ring part 21 and the ring part 31 are configured with components different from the connecting part 4.

Furthermore, by providing the two ring parts 21 and the two ring parts 31 each in a connected manner, the wire routing unit 1 according to the present embodiment can be properly fixed to the fixing target by suppressing the first fixing part 2 and the second fixing part 3 from rotating.

Note that the wire routing unit and the wire harness according to the present invention are not limited by the embodiment described above, and various changes are possible within the scope of the appended claims. The wire routing unit 1 and the wire harness WH according to the present embodiment may also be configured by combining the structural components of the embodiment described above as appropriate.

For example, as for the wire routing unit 1 and the wire harness WH according to the present embodiment described above, the first fixing part 2 and the second fixing part 3 as well as the connecting part 4 are configured with the same wire rod 41. However, the first fixing part 2 and the second fixing part 3 may be configured with members different from the connecting part 4. Even with such wire routing unit 1 and wire harness WH, the wires W can be properly routed through connecting the first fixing part 2 and the second fixing part 3 by the helically formed connecting part 4.

Furthermore, while the wire routing unit 1 and the wire harness WH according to the embodiment described above are provided with the first fixing part 2 that includes the two ring parts 21 and the second fixing part 3 that includes the two ring parts 31, the first fixing part 2 may include a single ring part 21 and the second fixing part 3 may include a single ring part 31. Even with such wire routing unit 1 and wire harness WH, the wires W can be properly routed through connecting the first fixing part 2 and the second fixing part 3 by the helically formed connecting part 4.

According to the wire routing unit and the wire harness according to the present embodiment, wires can be properly routed along the routing path and the number of components can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire routing unit comprising:
a first fixing part that is fixed to a fixing target;
a second fixing part that is fixed to the fixing target; and
a connecting part that has flexibility and connects the first fixing part and the second fixing part, wherein
the connecting part is formed by winding a wire rod in a helical manner, and allows a wire to be inserted into an inside and held.

2. The wire routing unit according to claim 1, wherein the first fixing part and the second fixing part each include a ring part that is formed in an annular shape by extending, from the connecting part, the wire rod that forms the connecting part.

3. The wire routing unit according to claim 2, wherein, in each of the first fixing part and the second fixing part, two of the ring parts are provided in a connected manner.

4. A wire harness comprising:
a wire; and
a wire routing unit assembled to the wire, wherein
the wire routing unit comprises:
a first fixing part that is fixed to a fixing target;
a second fixing part that is fixed to the fixing target; and
a connecting part that has flexibility and connects the first fixing part and the second fixing part, and
the connecting part is formed by winding a wire rod in a helical manner, and allows the wire to be inserted into an inside and held.
